(19) United States
(12) Patent Application Publication
(10) Pub. No.: US 2020/0126339 A1
(43) Pub. Date: Apr. 23, 2020

(54) PAPER MONEY HANDLING APPARATUS

(71) Applicant: FUJITSU FRONTECH LIMITED, Tokyo (JP)

(72) Inventors: Tomoyuki TAMAHASHI, Inagi (JP); Daiki HARAI, Inagi (JP); Koichi HOSOYAMA, Inagi (JP); Hiroshi YANAGIDA, Inagi (JP)

(21) Appl. No.: 16/721,256

(22) Filed: Dec. 19, 2019

Related U.S. Application Data
(63) Continuation of application No. PCT/JP2017/026426, filed on Jul. 21, 2017.

(51) Int. Cl. G07D 11/14; G07D 11/40; G07D 11/235; G07D 11/13

(52) U.S. Cl. CPC G07D 11/14; G07D 11/40; G07D 11/34; G07D 11/13; G07D 2211/00; G07D 11/235

(57) ABSTRACT

A paper money handling apparatus includes a dispenser unit to dispense paper money, a pressing unit to move between a pressing position at which the pressing unit presses dispensed paper money that is the paper money dispensed to the dispenser unit and a retraction position to which the pressing unit is retracted from the pressing position, a drive unit to move the pressing unit, a placement unit on which at least one portion of the dispensed paper money is placed, a clamp detection sensor to detect that the dispensed paper money is clamped between the pressing unit and the placement unit, a take-in carrier to take the dispensed paper money in an interior of the apparatus, a paper money detection sensor to detect presence/absence of the dispensed paper money, and a controller, when the dispensed paper money being remaining is detected by the paper money detection sensor, to control the drive unit to cause the pressing unit to move to the pressing position, and when the clamp detection sensor detects the dispensed paper money being clamped, the controller controls the take-in carrier to take the dispensed paper money in the interior of the apparatus.

### CROSS-REFERENCE TO RELATED APPLICATION

This application is continuation application of International Application PCT/JP2017/026426 filed on Jul. 21, 2017 and designated the U.S., the entire contents of which are incorporated herein by reference.

### FIELD

The present embodiments relates to a paper money handling apparatus that takes in paper money remaining in a dispenser unit.

### BACKGROUND

Conventionally, a paper money handling apparatus has been known in which when paper money dispensed to a dispenser unit remains unretrieved by a customer, the paper money remaining in the dispenser unit is taken into the apparatus (see Japanese Laid-Open Patent Publication No. S63-257886 and Japanese Patent No. 5335878 as an example).

As a method of taking paper money remaining in a dispenser unit into an apparatus, a method that has been proposed includes clamping paper money remaining in a paper money slot with a belt conveyer, opening a gate that makes/breaks a communicating state between the paper money slot and a left-money collection box, and taking the remaining paper money into the left-money collection box by the belt conveyer (see Japanese Laid-Open Patent Publication No. S63-257886 as an example).

### SUMMARY

In one aspect, a paper money handling apparatus includes a dispenser unit to dispense paper money, a pressing unit to move between a pressing position at which the pressing unit presses dispensed paper money that is the paper money dispensed to the dispenser unit and a retraction position to which the pressing unit is retracted from the pressing position, a drive unit to move the pressing unit, a placement unit on which at least one portion of the dispensed paper money is placed, a clamp detection sensor to detect that the dispensed paper money is clamped between the pressing unit and the placement unit, a take-in carrier to take the dispensed paper money in an interior of the apparatus, a paper money detection sensor to detect presence or absence of the dispensed paper money, and a controller to control the drive unit to cause the pressing unit to move to the pressing position when the dispensed paper money being remaining is detected by the paper money detection sensor, and the controller controls the take-in carrier to take the dispensed paper money in the interior of the apparatus when the clamp detection sensor detects the dispensed paper money being clamped.

### BRIEF DESCRIPTION OF DRAWINGS

FIG. 1 is a left side view illustrating a paper money handling apparatus;

FIG. 2 is a block diagram illustrating a schematic configuration of the paper money handling apparatus;

FIG. 3 is a flowchart for explaining a take-in operation of dispensed paper money;

FIG. 4 is a right side view illustrating a top module and a take-in and recycle module;

FIG. 5A is an explanatory diagram (1) for explaining an overview of the take-in operation of the dispensed paper money;

FIG. 5B is an explanatory diagram (2) for explaining an overview of the take-in operation of the dispensed paper money;

FIG. 5C is an explanatory diagram (3) for explaining an overview of the take-in operation of the dispensed paper money;

FIG. 6A is an explanatory diagram (1) for explaining details of the take-in operation of the dispensed paper money;

FIG. 6B is an explanatory diagram (2) for explaining details of the take-in operation of the dispensed paper money;

FIG. 6C is an explanatory diagram (3) for explaining details of the take-in operation of the dispensed paper money;

FIG. 6D is an explanatory diagram (4) for explaining details of the take-in operation of the dispensed paper money; and

FIG. 6E is an explanatory diagram (5) for explaining details of the take-in operation of the dispensed paper money.

### DESCRIPTION OF EMBODIMENTS

Paper money dispensed to a dispenser unit may be a few pieces of paper money or may be a bundle of several ten pieces of paper money. When paper money is taken into an apparatus by clamping the paper money by a belt conveyer as described above, with a setting of strong clamping force suitable for a few pieces of paper money, for example, a malfunctioning take-in operation may occur or the paper money may be damaged due to a load to carry the paper money generated as a clamping force becomes stronger particularly for a bundle of several ten pieces of paper money.

In the following description, a paper money handling apparatus according to one of embodiments of the present invention is explained with reference to drawings.

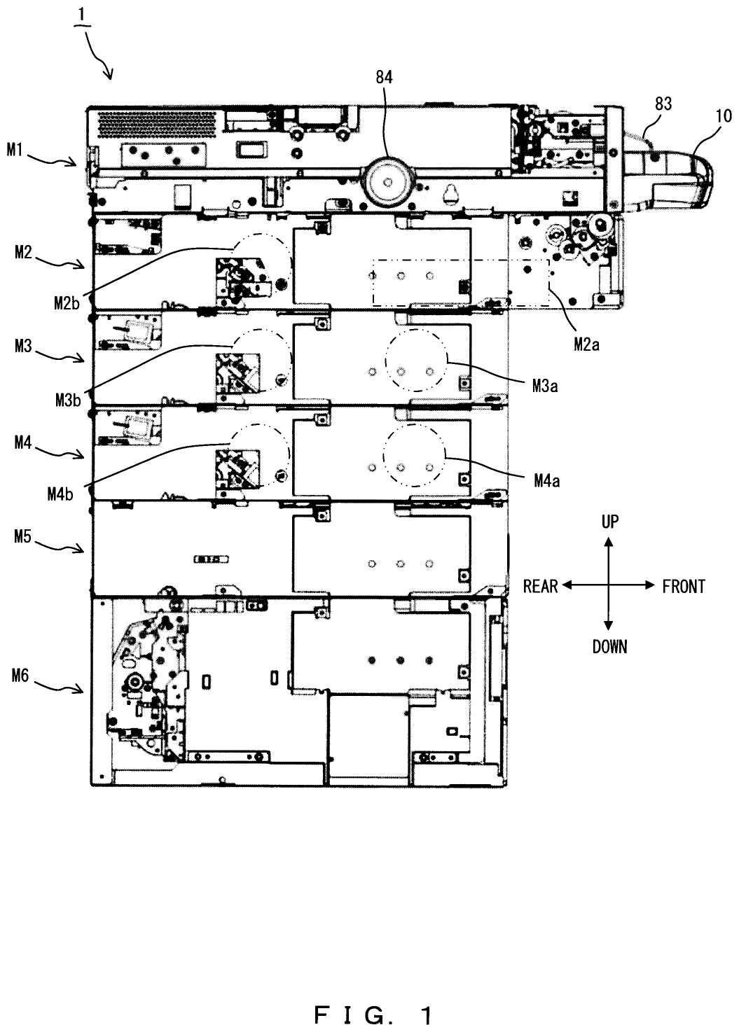

FIG. 1 is a left side view of a paper money handling apparatus 1.

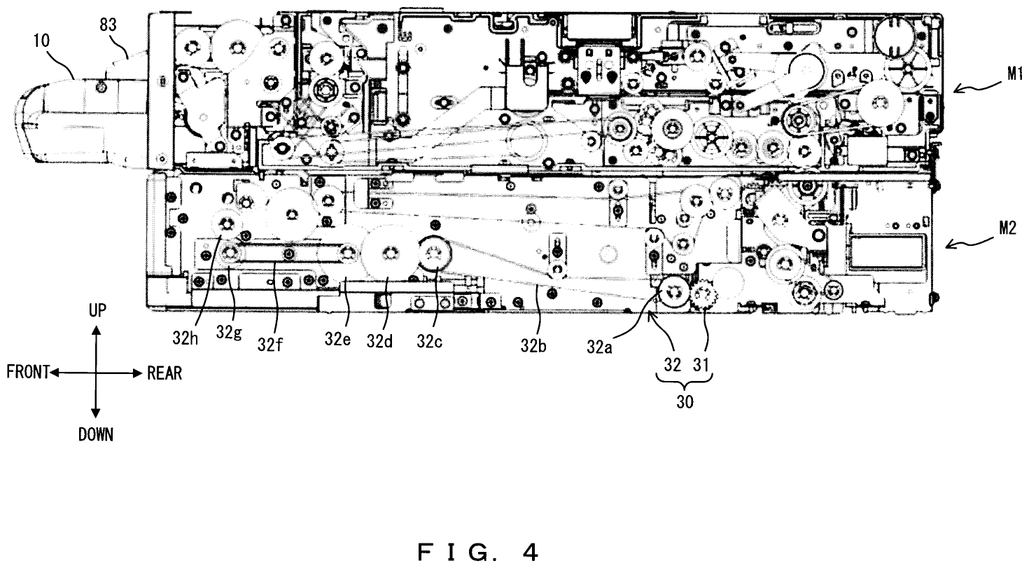

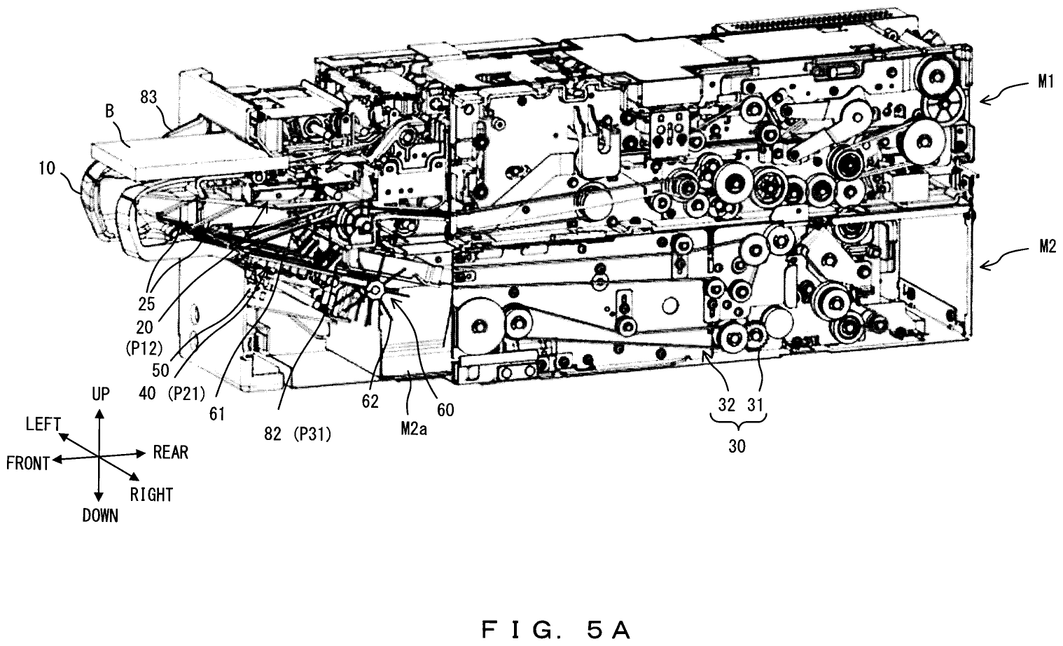

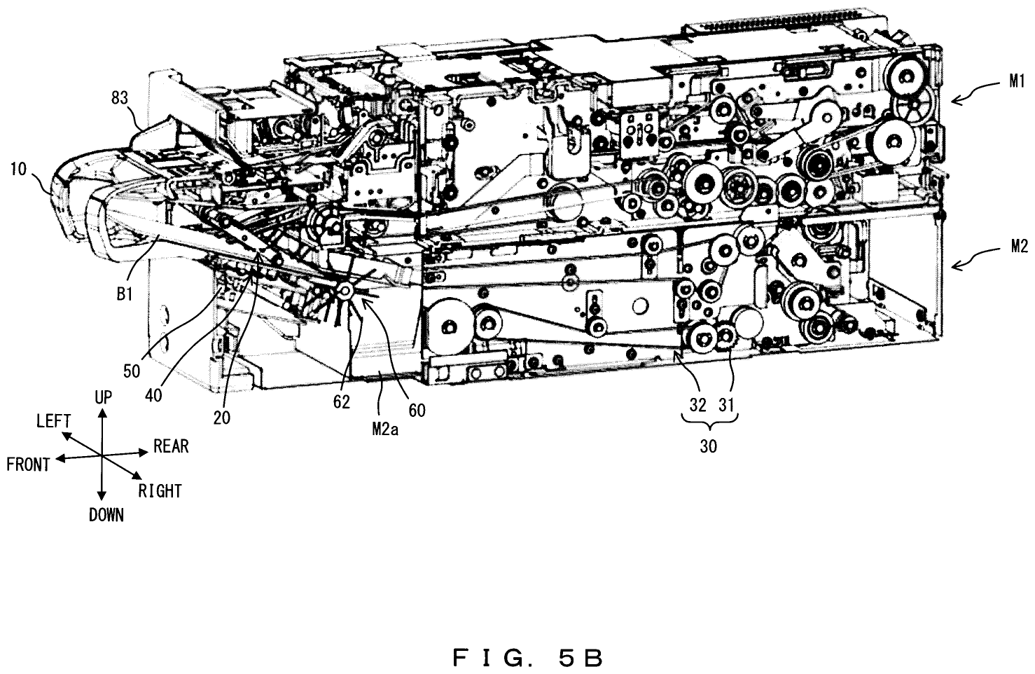

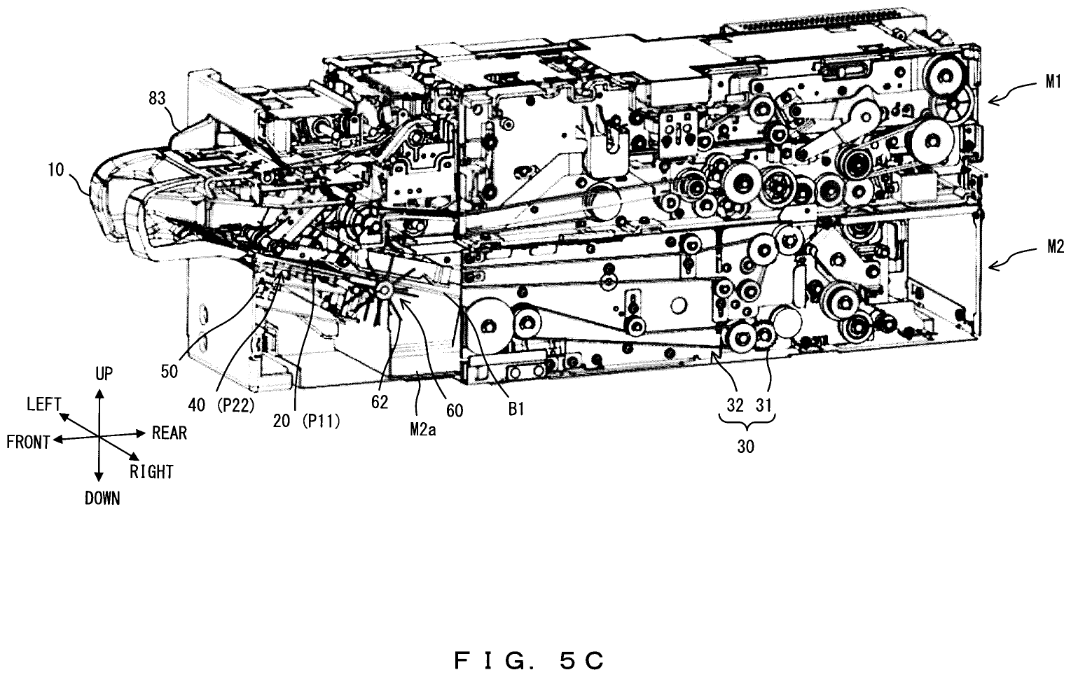

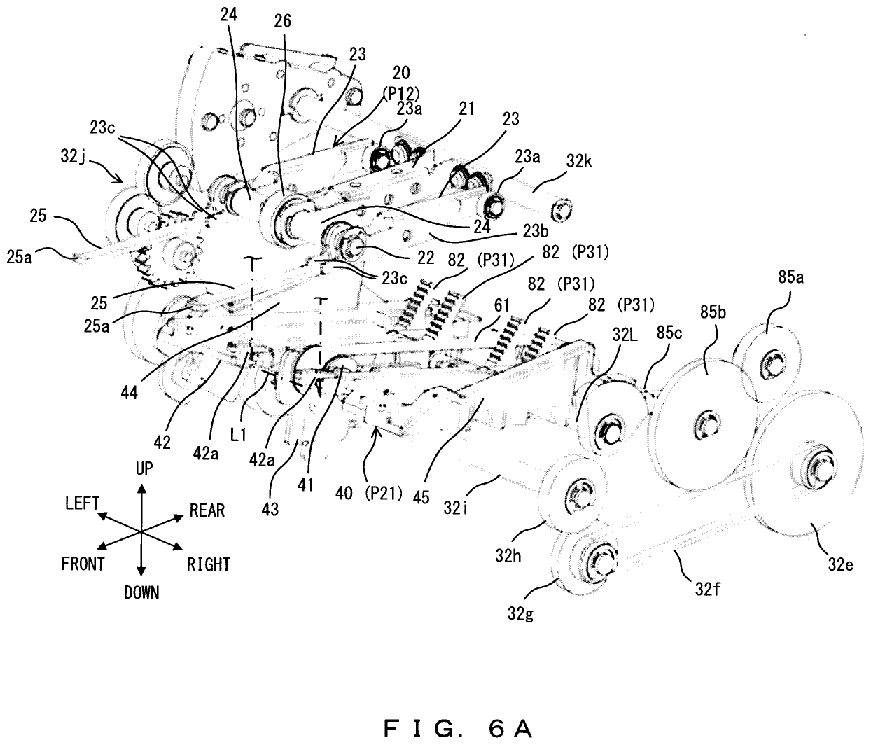

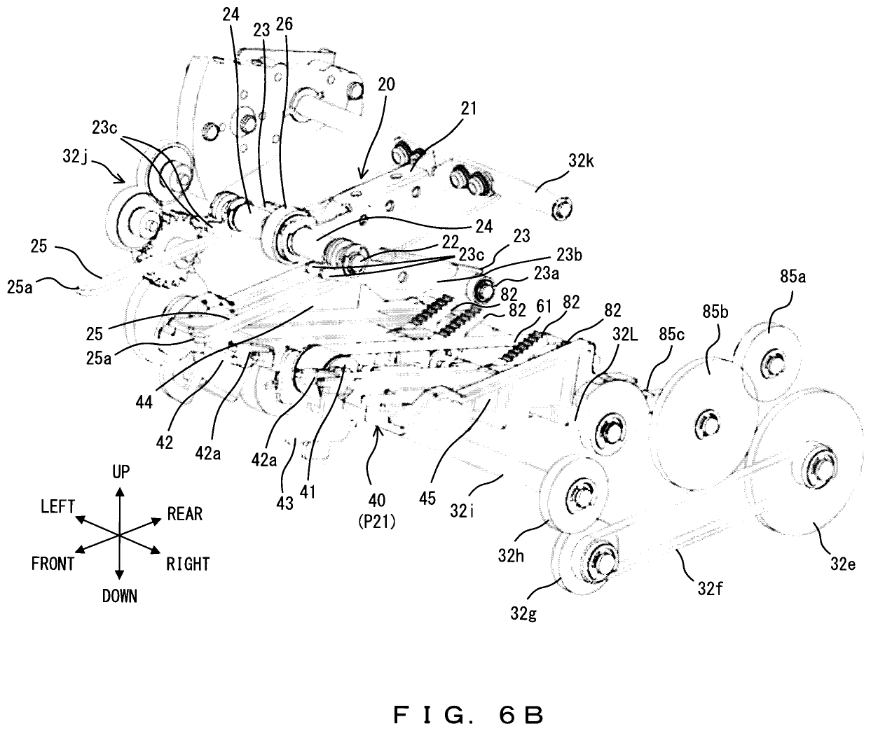

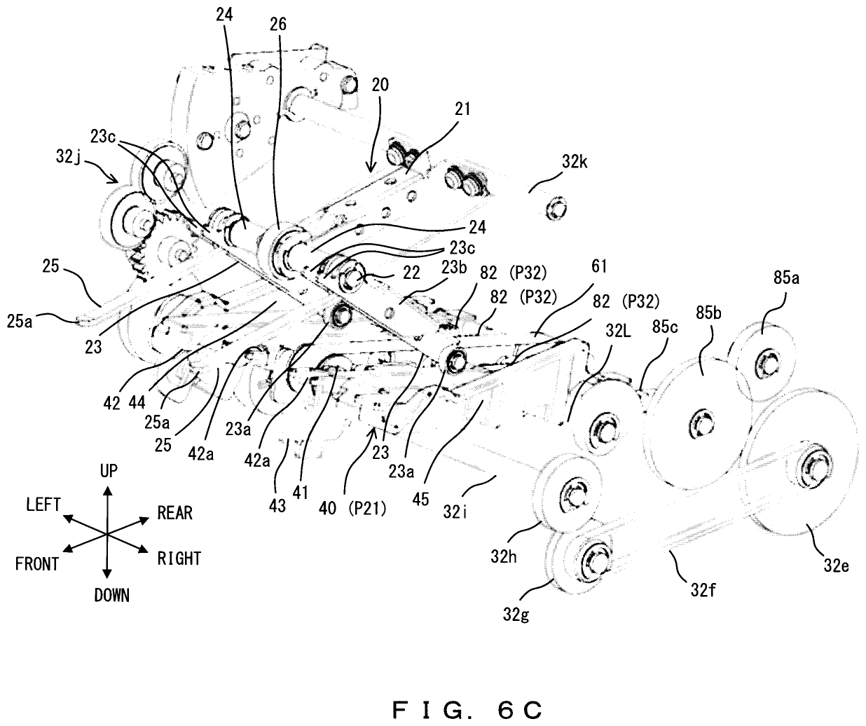

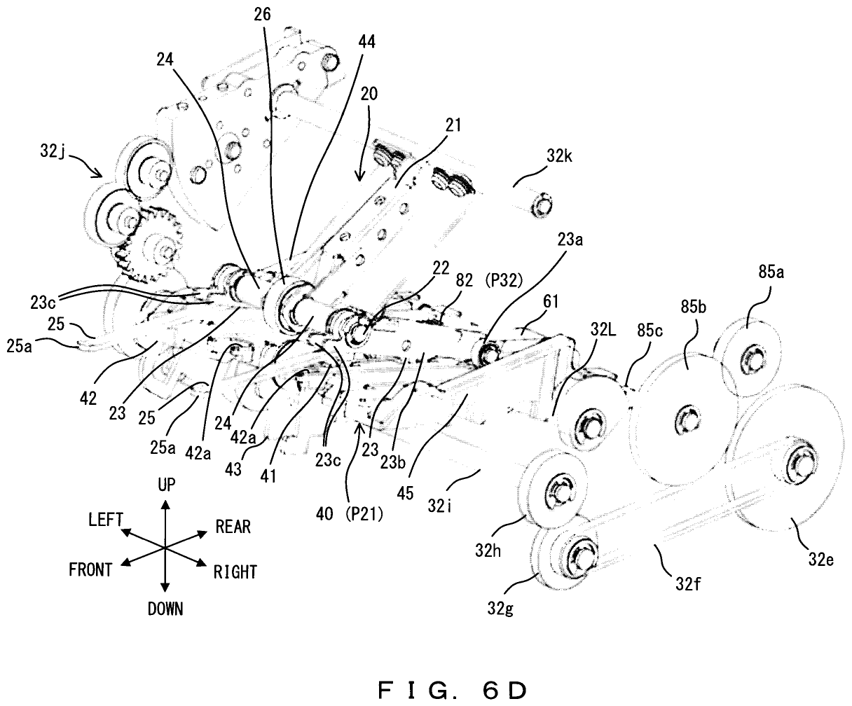

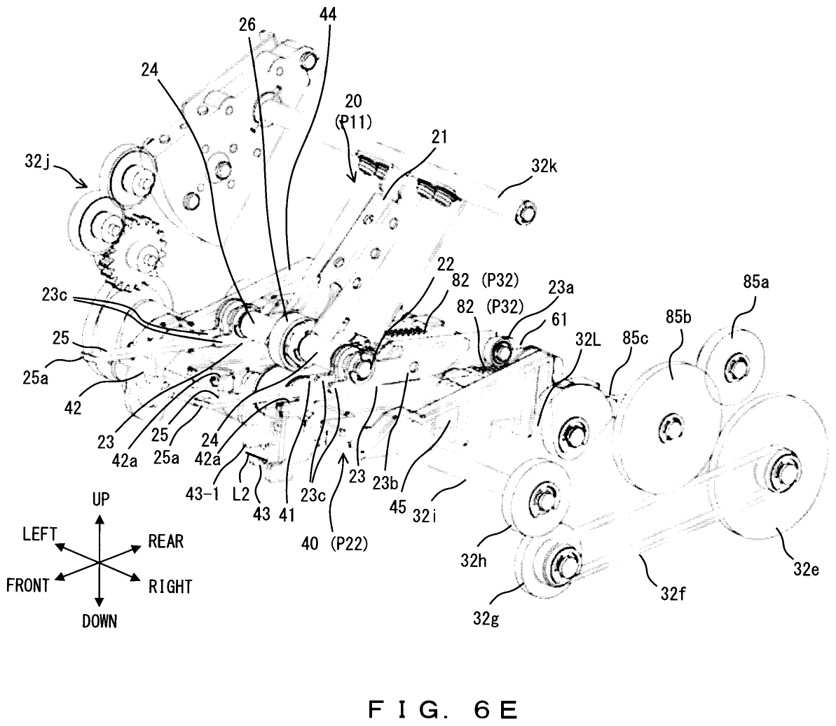

Note that for convenience in explanation, a front-to-rear direction, a left-to-right direction, and an up-to-down direction are indicated in FIG. 1, and also in FIG. 4, FIG. 5A to FIG. 5C and FIG. 6A to FIG. 6E, which are described later. This is merely an example, but the front-to-rear direction and the left-to-right direction are horizontal directions and the up-to-down direction is a vertical direction.

As illustrated in FIG. 1, the paper money handling apparatus 1 includes a top module M1, a take-in and recycle module M2, recycle modules M3 and M4, a supplementary module M5, and a collection module M6 in this order from the top. The top module M1 has a deposit unit 83 for receiving paper money B (see FIG. 5A) and a dispenser unit 10 for dispensing the paper money B, both of which are provided in a front edge that is projected toward the front. The top module M1 also has a DC motor 84 that causes a take-in carrier 60, which is described later, to operate. The DC motor 84 is, for example, a drive source for carrier that can be used for carrying the paper money B in addition to a take-in operation of the dispensed paper money B1. Moreover, the top module M1 has a discrimination unit that discriminates the paper money B received from the deposit unit 83 and a carrier unit that carries the paper money B.

The take-in and recycle module M2 and the recycle modules M3 and M4 have paper money containment units M2a, M2b, M3a, M3b, M4a, and M4b, each being arranged in the front portion or the rear portion of respective modules, and also have a carrier unit that carries the paper money B. The take-in and recycle module M2 and the recycle modules M3 and M4 are an example of plural containment modules that are layered under the top module M1. Note that the housing, the I/O board, and the paper money containment unit M3b or M4b located in the rear portion of the recycle module M3 or M4 can be used for the take-in and recycle module M2, and in that case, instead of the paper money containment unit M3a or M4a located in the front portion, the paper money containment unit M2a for containing dispensed paper money B1 that remains unretrieved and the other components may be arranged.

When dispensed paper money B1 (FIG. 5B) that is the paper money B dispensed to the dispenser unit 10 remains unretrieved by a customer, the take-in carrier 60 illustrated in FIG. 5A to FIG. 5C takes the dispensed paper money B1 into the paper money containment unit M2a located in the front portion of the take-in and recycle module M2 that is located on the top of the above-described containment modules. This is merely an example, but the paper money containment unit M2a can contain 100 pieces of dispensed paper money B1. In this case, even when the paper money containment unit M2a has already contained 60 pieces of dispensed paper money B1, and the number of pieces of paper money B that can be dispensed at the same time to the dispensed unit 10 is more than 40 pieces (e.g., 50 pieces), the number of pieces of paper money B dispensed can be limited to 40 pieces to prepare for a take-in operation. Note that because the paper money handling apparatus 1 records paper money serial numbers of paper money B to be dispensed, when the dispensed paper money B1 to be taken in is illicitly retrieved by a customer during a take-in operation, the dispensed paper money B1 that was illicitly retrieved can be identified from the paper money serial numbers.

The paper money containment unit M2a contains stacked dispensed paper money B1 and other paper money containment units M2b, M3a, M3b, M4a, and M4b contain the paper money B wrapped with a film. The film-wrapped paper money B is recycled for dispensing.

Note that the dispensed paper money B1 that is taken in from the dispensing unit 10 is not always contained in the paper money containment unit M2a, but may be contained in other paper money containment units M2b, M3a, M3b, M4a, and M4b to be recycled for dispensing, or may be contained in the collection module M6 described later. When the paper money containment unit M2b located in the rear portion is not provided in the take-in and recycle module M2, by taking advantage of the space, dispensed paper money B1 in a larger size can be retrieved, or the number of pieces of the dispensed paper money B1 retrieved can be increased.

The supplementary module M5 contains paper money B used for dispensing. The collection module M6 contains paper money B that is not recycled from among paper money B deposited.

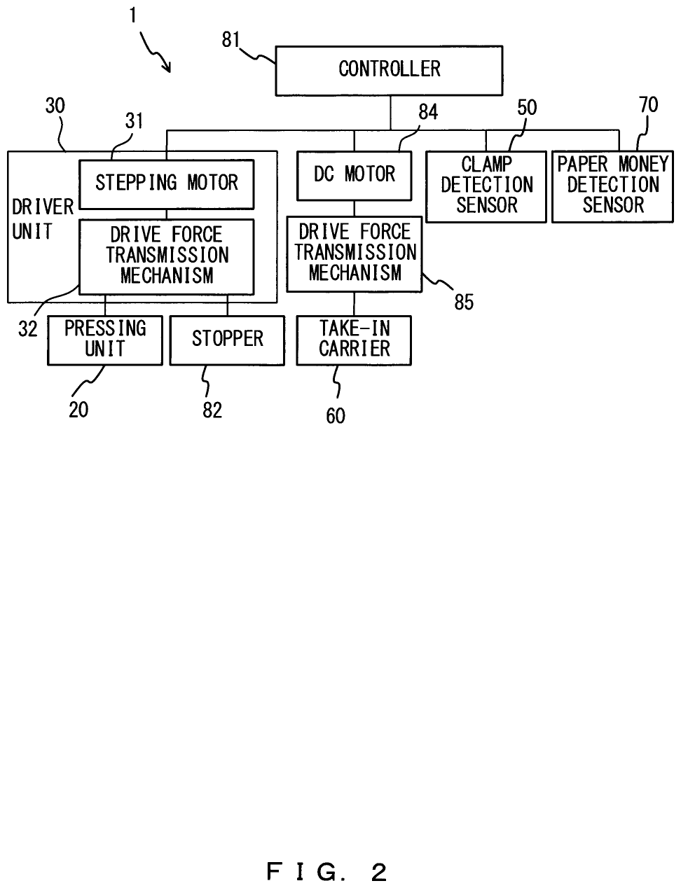

FIG. 2 is a block diagram illustrating a schematic configuration of the paper money handling apparatus 1.

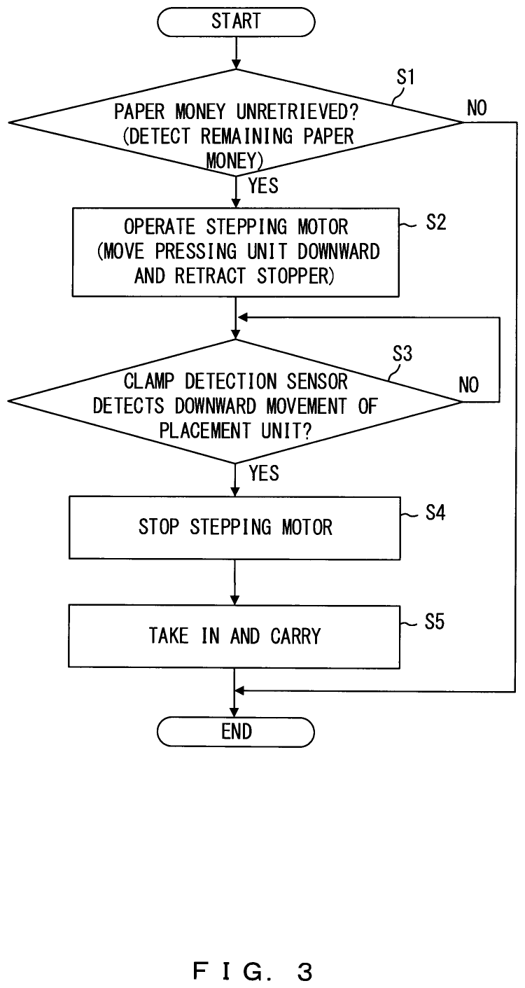

FIG. 3 is a flowchart that explains a take-in operation of the dispensed paper money B1.

FIG. 4 is a right side view illustrating the top module M1 and the take-in and recycle module M2.

FIG. 5A to FIG. 5C are explanatory diagrams that explain an overview of the take-in operation of the dispensed paper money B1.

FIG. 6A to FIG. 6E are explanatory diagrams that explain details of the take-in operation of the dispensed paper money B1.

The paper money handling apparatus 1 includes a dispenser unit 10, a pressing unit 20, a drive unit 30, a placement unit 40, a clamp detection sensor 50, a take-in carrier 60, a paper money detection sensor 70, and a controller 81. The paper money handling apparatus 1 may also include a stopper 82, a deposit unit 83, a DC motor 84, and a drive force transmission mechanism 85.

When the paper money detection sensor 70 detects remaining dispensed paper money B1, the controller 81 moves the pressing unit 20 to a pressing position P11 (see FIG. 5C and FIG. 6E) and controls a stepping motor 31 to move the stopper 82 to a retraction position P32 (see FIG. 6C to FIG. 6E), and more details are explained later. When the clamp detection sensor 50 detects that the placement unit 40 is pressed and is moved down by the pressing unit 20 with the dispensed paper money B1 in between, the controller 81 stops the operation of the stepping motor 31 and controls the take-in carrier 60 (the DC motor 84) so as to take the dispensed paper money B1 into the paper money containment unit M2a (see FIG. 1 and FIG. 5A to FIG. 5C).

In the following description, each of the units in the paper money handling apparatus 1 is explained.

As illustrated in FIG. 6A to FIG. 6E, the pressing unit 20 has a first arm 21, a connecting shaft 22, a second arm 23, a torsion spring 24, a hold member 25, and a roller 26. The pressing unit 20 moves between a pressing position P11 (see FIG. 5C and FIG. 6E) at which the pressing unit 20 presses dispensed paper money B1 (see FIG. 5B) and a retraction position P12 (see FIG. 5A and FIG. 6A) to which the pressing unit 20 is retracted from the pressing position P11. Note that the configuration of the pressing unit 20 is merely a preferable example, and other configurations may be used as long as the pressing unit 20 moves between the pressing position P11 at which the pressing unit 20 presses the dispensed paper money B1 and the retraction position P12 to which the pressing unit 20 is retracted from the pressing position P11.

As illustrated in FIG. 6A to FIG. 6E, one end of the first arm 21 is fixed at a rotary shaft 32k of the drive force transmission mechanism 32 that is rotated by the operation of the drive unit 30.

The connecting shaft 22 is provided at another end of the first arm 21. The second arm 23 and the hold member 25 are connected to the connecting shaft 22 on each of two sides of a connecting portion at which the connecting shaft 22 and the first arm 21 are connected to each other. Note that two second arms 23 and two hold members 25 are connected to the connecting shaft 22, but the number of the second arms 23 and that of the hold members 25 may be one or may be three or more.

the second arm 23 has a roller 23a that is a bearing, for example, at a free end that is an end opposite to the end connected to the connecting shaft 22. The second arm 23 is biased downward by the torsion spring 24, which is an example of an elastic body, so that a side of the roller 23a (the free end) becomes closer to the dispensed paper money B1. The torsion spring 24 with one end fixed on the first arm 21 is wound around the connecting shaft 22.

With this configuration, in the process of the pressing unit 20 moving from the retraction position P12 illustrated in FIG. 6A to the pressing position P11 illustrated in FIG. 6E as the first arm 21 rotates anticlockwise with the rotary shaft 32k in FIG. 6A to FIG. 6E, the second arm 23 is biased toward a side of the dispensed paper money B1 by a biasing force of the torsion spring 24. As a result, the roller 23a of the second arm 23 is the first portion of the pressing unit 20 to contact with the dispensed paper money B1 as illustrated in FIG. 6C.

The second arm 23 has a guide unit 23b provided to project toward the side of the dispensed paper money B1 so as to be able to contact with the dispensed paper money B1. In the guide unit 23b, two projections 23c and 23c are provided at an end opposite to the side on which the roller 23a is provided. The projections 23c and 23c contact with a leaf spring provided on an immovably-fixed member in the top module M1 or the take-in and recycle module M2 and are biased downward when the pressing unit 20 is at the retraction position P12 as illustrated in FIG. 6A. As a result, when the pressing unit 20 is at the retraction position P12, the second arm 23 rotates upward (anticlockwise in FIG. 6A) from the side of the roller 23a against the biasing force of the torsion spring 24 and the second arm 23 becomes more parallel to the first arm 21.

The hold member 25 has a long plate-like shape and one end is rotatably connected to the connecting shaft 22. The hold member 25 is arranged to drop forward by self-weight, for example, and holds the dispensed paper money B1 from a stage prior to the dispensed paper money B1 being dispensed to the dispenser unit 10. The tip that is a free end of the hold member 25 has a tip bend 25a that is bent so that a plane of the tip contacting with the dispensed paper money B1 is parallel to the dispensed paper money B1. The hold member 25 preferably holds the dispensed paper money B1 at least when the pressing unit 20 is at the retraction position P12, but also holds the dispensed paper money B1 when the pressing unit 20 is at the pressing position P11. Note that illustration of the hold member 25 is omitted in FIG. 5B and FIG. 5C.

The roller 26 is provided at the center of the connecting shaft 22 in the left-to-right direction, and when the pressing unit 20 moves to the pressing position P11, the roller 26 comes into contact with a roller 41 around which a carrier belt 61 of the take-in carrier 60 is wound having the dispensed paper money B1 and the carrier belt 61 in between.

As illustrated in FIG. 4, the drive unit 30 has a stepping motor 31 that is an example of a drive source arranged in the take-in and recycle module M2 and a drive force transmission mechanism 32 that transmits the drive force of the stepping motor 31 to each of the pressing unit 20 and the stopper 82.

The drive force transmission mechanism 32 has gears 32a, 32c, 32d, 32e, 32g, and 32h and transmission belts 32b and 32f that are arranged on the right side of the paper money handling apparatus 1, and the drive force transmitted by these components is transmitted toward the left side of the paper money handling apparatus 1 via a rotary shaft 32i illustrated in FIG. 6A to FIG. 6E. The drive force is transmitted via a gear train 32j to a rotary shaft 32k that rotates the first arm 21 of the pressing unit 20 and a rotary shaft 32L that rotates the stopper 82. Note that separate drive units 30 may be arranged for moving the pressing unit 20 and for moving the stopper 82, but as described above, by means of a configuration in which the drive force generated by a single drive source (stepping motor 31) is transmitted to both the pressing unit 20 and the stopper 82 by the drive force transmission mechanism 32, the number of drive sources can be reduced and as a result, the paper money handling apparatus 1 can be simplified.

The placement unit 40 has a roller 41, a plate 42, a projection for detection 43, and left- and right-side walls 44 and 45 and moves down from a first position P21 illustrated in FIG. 6A to FIG. 6D to a second position P22 illustrated in FIG. 6E when the placement unit 40 is pressed by the pressing unit 20 with the dispensed paper money B1 in between. The placement unit 40 is biased upward to the first position P21 by an elastic body that is not illustrated in the drawings. For that reason, the placement unit 40 is at the first position P21 in a state of not being pressed by the pressing unit 20, and when the placement unit 40 is pressed by the pressing unit 20 against the bias force of the elastic body, the placement unit 40 moves down to the second position P22. Note that in the downward movement of the placement unit 40, only the front side of the placement unit 40 is moved down in a rotary movement, but the entirety of the placement unit 40 may be moved down.

The plate 42 has grooves and holes to avoid interference from the carrier belt 61 or the stopper 82. As illustrated in FIG. 5B, a portion on the rear side of the dispensed paper money B1 is placed on the plate 42. Note that the paper money B dispensed to the dispenser unit 10 is carried forward in the top module M1 and is also carried obliquely upward along the placement unit 40 to the dispenser unit 10. Then the front side of the paper money B is placed on the bottom of the dispenser unit 10 and the rear side is placed on the plate 42.

As illustrated in FIG. 6A, two semicircular cutouts 42a and 42a are provided on the front edge of the plate 42. A pair of prisms, which is not illustrated, is arranged under the cutouts 42a and 42a. One of the cutouts 42a and 42a passes through paper money detection light L1 (illustrated by a dash-dot-dash line in FIG. 6A) that is emitted downward from the paper money detection sensor 70 in FIG. 2, and another one passes through the paper money detection light L1 traveling upward to the paper money detection sensor 70 after the paper money detection light L1 is bent at the pair of prisms. Note that the detection of the dispensed paper money B1 by means of the paper money detection sensor 70 is not limited to the detection by using the paper money detection light L1 that passes through the cutout 42a, but any detection can be used as long as the presence/absence of the dispensed paper money B1 can be detected, and a position of the detection is not limited in particular.

The projection for detection 43 projecting downward is provided at the front edge of the plate 42. As illustrated in FIG. 6E, this projection for detection 43 blocks clamp detection light L2 (illustrated by a bold line in FIG. 6E) of the clamp detection sensor 50 that is a light blocking sensor illustrated in FIG. 2 and FIG. 5A to FIG. 5C, only when the placement unit 40 is moved down to the second position P22. Note that a projection for detection 43-1 illustrated by a dash-dot-dot-dash line in FIG. 6E that is a projection for detection when the placement unit 40 is at the first position P21 does not block the clamp detection light L2.

The clamp detection sensor 50 is not limited to a sensor that detects the clamp detection light L2 being blocked by the projection for detection 43, but may be other sensors as long as the sensor can detect that the placement unit 40 is moved down to the second position P22. Moreover, the clamp detection sensor 50 may be any sensor as long as the sensor can detect the dispensed paper money B1 being clamped between the pressing unit 20 and the placement unit 40. When the pressing unit 20 is provided so that a portion of the pressing unit 20 contacting with the dispensed paper money B1 moves up and down and is biased downward, the clamp detection sensor 50 may be a sensor detecting that this contacting portion moves upward at the time of pressing the dispensed paper money B1. Alternatively, the clamp detection sensor 50 may be a sensor detecting a load imposed on the pressing unit 20 at the time of pressing the dispensed paper money B1. The placement unit 40 therefore is not limited to a unit that moves down from the first position P21 to the second position P22, but may be immovably fixed in the take-in and recycle module M2.

The side walls 44 and 45 are provided so as to project upward on the left and right sides of the plate 42 and guide the side faces of the paper money B carried from the top module M1 to the dispenser unit 10 and the dispensed paper money B1 taken into the paper money containment unit M2a by the take-in carrier 60.

As illustrated in FIG. 5B and FIG. 5C, the take-in carrier 60 takes the dispensed paper money B1 into the paper money containment unit M2a by using the above-described carrier belt 61 and a bladed wheel 62.

The controller 81 has, for example, a processor (e.g., CPU: Central Processing Unit) that functions as an arithmetic processing unit controlling the operations of the entirety of the paper money handling device 1 and a storage unit such as a memory.

As described above, when the paper money detection sensor 70 detects remaining dispensed paper money B1, the controller 81 controls the drive unit 30 to cause the pressing unit 20 to move to the pressing unit P21 and to cause the stopper 82 to move to the retraction position P32. When the clamp detection sensor 50 detects a downward movement of the placement unit 40, or in other words, detects dispensed paper money B1 being clamped, the controller 81 controls the take-in carrier 60 to take the dispensed paper money B1 into the paper money containment unit M2a. For example, the controller 81 controls the take-in carrier 60, for example, by operating the DC motor 84 and transmitting the drive force generated by the DC motor 84 to the take-in carrier 60 via the drive force transmission mechanism 85.

The stopper 82 moves between a control position P31 illustrated in FIG. 5A and FIG. 6A that controls a position of a rear edge on a side of the interior of the apparatus (the paper money containment unit M2a) of the dispensed paper money B1 and a retraction position P32 illustrated in FIG. 6C to FIG. 6E to which the stopper 82 is retracted from the control position P31. As described above, the stopper 82 rotates together with a rotary shaft 32L by the drive force of the stepping motor 31 transmitted via the drive force transmission mechanism 32. Note that after the stopper 82 fell down to the retraction position P32 as illustrated in FIG. 6C, the stopper 82 is in contact with other members, and when this load is detected by a torque limiter provided on the rotary shaft 32L, only the rotation of the rotary shaft 32L may be stopped during the rotation of the pressing unit 20 (the first arm 21). Alternatively, the rotation of the rotary shaft 32L may not be stopped after the stopper 82 fell down to the retraction position P32 when there is a space where the rotary shaft 32L can keep rotating. Note that when the stopper 82 falls down to the retraction position P32, the dispensed paper money B1 may be clamped between at least a portion of the pressing unit 20 (the roller 23a of the second arm 23) and the placement unit 40 as illustrated in FIG. 6C.

The deposit unit 83 is provided above the dispenser unit 10 as illustrated in FIG. 5A. Paper money B is inserted into the top module M1 while being guided by the top face of the dispenser unit 10. The paper money B is carried to the paper money containment unit M2b, Mia, M3b, M4a, or M4b of the take-in and recycle module M2, or the recycle modules M3 and M4, or the collection module M6 as illustrated in FIG. 1, after going through the discrimination unit in the top module M1.

The drive force generated by the DC motor 84 illustrated in FIG. 1 and FIG. 2 is transmitted to the carrier belt 61 via the drive force transmission mechanism 85 that has gears 85a and 85b and the rotary shaft 85c illustrated in FIG. 6A to FIG. 6E.

In the following description, a take-in operation of dispensed paper money B1 is explained along with the flowchart in FIG. 3. However, explanations of matters overlapping with the descriptions provided above are omitted as appropriate.

First, the controller 81 detects remaining (unretrieved) dispensed paper money B1 by means of the paper money detection sensor 70 (step S1).

The controller 81 determines dispensed paper money B1 to be remaining, for example, by determining whether the dispensed paper money B1 remains in the dispenser unit 10 after a certain period of time has elapsed since paper money B was dispensed to the dispenser unit 10 or not. Alternatively, the controller 81 may determine dispensed paper money B1 to be remaining by determining whether the dispensed paper money B1 remains in the dispenser unit 10 or not when a customer moves away from the paper money handling apparatus 1 based on an image captured by an imaging device of the paper money handling apparatus 1 or a detection result of a human detecting sensor.

When the controller 81 determines the dispensed paper money B1 to be not remaining (step S1: NO), the processing in FIG. 3 is ended.

When the controller 81 determines the dispensed paper money B1 to be remaining (step S1: YES), the controller 81 controls the stepping motor 31 (the drive unit 30) to cause the pressing unit 20 to move to the pressing position P11 (see FIG. 5C and FIG. 6E) and to cause the stopper 82 to move to the retraction position P32 (step S2).

The controller 81 causes the clamp detection sensor 50 to detect whether the placement unit 40 is pressed by the pressing unit 20 with the dispensed paper money B1 in between and is moved down from the first portion P21 to the second position P22 or not and repeats the detection until the downward movement of the placement unit 40 is detected.

When the downward movement of the placement unit 40 is detected (step S3: YES), the controller unit 81 stops the operation of the stepping motor 31 (step S4) and controls the take-in carrier 60 (the DC motor 84) to take the dispensed paper money B1 in the paper money containment unit M2a (step S5).

Note that, as the number of pieces of the dispensed paper money B1 is reduced in the process of the take-in operation of dispensed paper money B1, the pressing force of the pressing unit 20 against the placement unit 40 becomes weak and the placement unit 40 moves upward to the first position P21 or to a position between the first position P21 and the second position P22. As a result, the clamp detection sensor 50 may not detect the downward movement of the placement unit 40. In this case, the controller 81 may repeat the processing from the processing in step S2, or more specifically, the processing of operating the stepping motor 31 (the drive unit 30). After the downward movement of the placement unit 40 is detected again (step S3: YES), the controller 81 may stop the operation of the stepping motor 31 (step S4) and may resume taking in and carrying (step S5). In this case, although the operation of the stepping motor 31 is resumed, the stopper 82 has already fallen down to the retraction position P32. Then, as described above, the stopper 82 is in contact with other members, and when this load is detected by a torque limiter etc. provided on the rotary shaft 32L, only the rotation of the rotary shaft 32L may be stopped even though the pressing unit 20 is moving to the pressing position P11.

Regarding the processing after the taking in and carrying paper money is ended, when the paper money detection sensor 70 detects that dispensed paper money B1 is not present in the placement unit 40, the controller 81 operates the stepping motor 31, moves the pressing unit 20 to the retraction position P12, and moves the stopper 82 to the control position P31. When the completion of the downward movement of the pressing unit 20 to the retraction position P12 is detected by a sensor etc., the controller 81 stops the stepping motor 31.

In the present embodiments described above, the paper money handling apparatus 1 includes a dispenser unit 10, a pressing unit 20, a drive unit 30, a placement unit 40, a clamp detection sensor 50, a take-in carrier 60, a paper money detection sensor 70, and a controller 81. The dispenser unit 10 is arranged to dispense paper money B. The pressing unit 20 moves between a pressing position P11 at which the pressing unit 20 presses dispensed paper money B1 that is the paper money B dispensed to the dispenser unit 10 and a retraction position P12 to which the pressing unit 20 is retracted from the pressing position P11. The drive unit 30 moves the pressing unit 20. At least a portion of the dispensed paper money B1 is placed on the placement unit 40. The clamp detection sensor 50 detects the dispensed paper money B1 being clamped between the pressing unit 20 and the placement unit 40. The take-in carrier 60 takes the dispensed paper money B1 in a paper money containment unit M2a that is an example of a side of the interior of the apparatus. The paper money detection sensor 70 detects the presence/absence of the dispensed paper money B1. When the paper money detection sensor 70 detects remaining dispensed paper money B1 (step S1 in FIG. 3: YES), the controller 81 controls the drive unit 30 (a stepping motor 31) to cause the pressing unit 20 to move to the pressing position P11 (step S2). When the clamp detection sensor 50 detects dispensed paper money B1 being clamped (step S3: YES), the controller 81 controls the take-in carrier 60 (the DC motor 84) to take the dispensed paper money B1 in the paper money containment unit M2a.

As described above, in the present embodiments, after detection of dispensed paper money B1 remaining in the dispenser unit 10 being clamped between the pressing unit 20 and the placement unit 40, the take-in carrier 60 takes the dispensed paper money B1 in the paper money containment unit M2a. On the other hand, in an aspect (a comparative example) that does not detect the dispensed paper money B1 being clamped between the pressing unit 20 and the placement unit 40, with a setting of strong clamping force suitable for a few pieces of dispensed paper money B1, for example, in order to enable the dispensed paper money B1 to be clamped regardless of the number of pieces of the dispensed paper money B1, a malfunctioning take-in operation may occur or the dispensed paper money B1 may be damaged due to a load to carry a bundle of dispensed paper money B1, particularly a bundle of several ten pieces of dispensed paper money B1. The setting of weak clamping force suitable for a bundle of several ten pieces of dispensed paper money B1, for example, could also cause a malfunctioning take-in operation failing to clamp a few pieces of dispensed paper money B1 in particular. In this regard, in the present embodiments, because dispensed paper money B1 is taken in the paper money containment unit M2a by the take-in carrier 60 after detection of the dispensed paper money B1 remaining in the dispenser unit 10 being clamped between the pressing unit 20 and the placement unit 40, as described above, the take-in carrier 60 can take the dispensed paper money B1 in the paper money containment unit M2a in a state that the dispensed paper money B1 is properly clamped between the pressing unit 20 and the placement unit 40.

Consequently, according to the present embodiments, occurrence of malfunctioning take-in operations of paper money B remaining in the dispenser unit 10 (dispensed paper money B1) can be controlled.

In addition, in the present embodiments, the placement unit 40 is pressed by the pressing unit 20 with dispensed paper money B1 in between and is moved down from the first position P21 to the second position P22 and the clamp detection sensor 50 detects the dispensed paper money B1 being clamped by detecting the placement unit 40 being at the second position P22. For that reason, the dispensed paper money B1 being clamped can be detected with a simple configuration.

Furthermore, in the present embodiments, the paper money handling apparatus 1 further includes a stopper 82 that moves between a control position P31 that controls a position of a rear edge of dispensed paper money B1 on a side of the paper money containment unit M2a and a retraction position P32 at which the stopper 82 is retracted to clear the control position P31. The drive unit 30 moves the pressing unit 20 and the stopper 82. The drive unit 30 has a stepping motor 31 that is an example of a drive source and a drive force transmission mechanism 32 that transmits drive force generated by a single stepping motor 31 to each of the pressing unit 20 and the stopper 82. When the paper money detection sensor 70 detects remaining dispensed paper money B1, the controller 81 controls the drive unit 30 (the stepping motor 31) to cause the pressing unit 20 to move to the pressing position P11 and to cause the stopper 82 to move to the retraction position P32. As described above, because the pressing unit 30 and the stopper 82 can be moved by a single stepping motor 31, a take-in operation of the dispensed paper money B1 can be carried out with a simple configuration.

In addition, in the present embodiments, the pressing unit 20 has a first arm 21 having one end fixed on a rotary shaft 32k that rotates by an operation of the drive unit 30, a connecting shaft 22 provided on another end of the first arm 21, a second arm 23 with one end connected to the connecting shaft 22 and contacting with dispensed paper money B1, and a torsion spring 24 that is an example of an elastic body fixed on the first arm 21 and biasing the second arm 23 toward a side of the dispensed paper money B1. Because of the above, the pressing unit 20 and the placement unit 40 can clamp the dispensed paper money B1 with a simple configuration.

Furthermore, in the present embodiments, the pressing unit 20 further has a hold member 25 with one end connected in a rotatable manner to the connecting shaft 22, and the hold member 25 holds dispensed paper money B1 at least when the pressing unit 20 is at the retraction position P12. Because of the above, the use of the pressing unit 20 enables holding the dispensed paper money B1 in the dispenser unit 10 in addition to clamping the dispensed paper money B1 between the pressing unit 20 and the placement unit 40.

Moreover, in the present embodiments, the paper money handling apparatus 1 further includes a top module M1 having a dispenser unit 10 at the front edge and a take-in and recycle module M2 and recycle modules M3 and M4 that are an example of plural containment modules layered under the top module M1 and each of the modules has paper money containment units M2a, M2b, M3a, M3b, M4a, or M4b for containing paper money B in each of the front and rear portions respectively. A take-in carrier 60 takes dispensed paper money B1 in the paper money containment unit M2a located in the front portion of the take-in and recycle module M2 that is located on the top of the take-in and recycle module M2 and recycle modules M3 and M4. Accordingly, the paper money containment unit M2b can be arranged in the rear portion of the take-in and recycle module M2 while reducing the carrying path of the dispensed paper money B1 in the take-in operation. In this manner, the configuration of the paper money handling apparatus 1 can be made simpler.

Note that the present invention is not limited to the embodiments described above, but components can be modified and embodied without departing from the scope of the invention at the implementation. In addition, various inventions may be formed by appropriate combination of multiple components disclosed in the embodiments. For example, all components provided in the embodiments may be combined as appropriate. In this manner, the present invention can take various modifications or applications without departing from the scope of the invention.

What is claimed is:

1. A paper money handling apparatus, comprising:
a dispenser unit configured to dispense paper money;
a pressing unit configured to move between a pressing position at which the pressing unit presses dispensed paper money that is the paper money dispensed to the dispenser unit and a retraction position to which the pressing unit is retracted from the pressing position;
a drive unit configured to move the pressing unit;
a placement unit on which at least one portion of the dispensed paper money is placed;
a clamp detection sensor configured to detect that the dispensed paper money is clamped between the pressing unit and the placement unit;
a take-in carrier configured to take the dispensed paper money in an interior of the apparatus;
a paper money detection sensor configured to detect presence or absence of the dispensed paper money; and
a controller configured to control the drive unit to cause the pressing unit to move to the pressing position when the dispensed paper money being remaining is detected by the paper money detection sensor,
wherein the controller controls the take-in carrier to take the dispensed paper money in the interior of the apparatus when the clamp detection sensor detects the dispensed paper money being clamped.

2. The paper money handling apparatus according to claim 1, wherein
the placement unit is pressed by the pressing unit with the dispensed paper money in between and moves down from a first position to a second position, and
the clamp detection sensor detects the dispensed paper money being clamped by detecting the placement unit being at the second position.

3. The paper money handling apparatus according to claim 1, further comprising
a stopper configured to move between a control position to control a rear edge of the dispensed paper money that is on a side of the interior of the apparatus and a retraction position to which the stopper is retracted from the control position,
wherein the drive unit moves the pressing unit and the stopper,
the drive unit has a single drive source and a drive force transmission mechanism that transmits drive force generated by the drive source to each of the pressing unit and the stopper, and
the controller controls the drive unit to cause the pressing unit to move to the pressing position and to cause the stopper to move to the retraction position when the dispensed paper money being remaining is detected by the paper money detection sensor.

4. The paper money handling apparatus according to claim 1, wherein
the pressing unit has a first arm having one end fixed on a rotary shaft that rotates by an operation of the drive unit, a connecting shaft provided on another end of the first arm, a second arm with one end connected to the connecting shaft and contacting with dispensed paper money, and an elastic body fixed on the first arm and biasing the second arm toward a side of the dispensed paper money.

5. The paper money handling apparatus according to claim 4, wherein
the pressing unit further comprises a hold member with one end connected in a rotatable manner to the connecting shaft, and
the hold member holds the dispensed paper money when the pressing unit is at least at the retraction position.

6. The paper money handling apparatus according to claim 1, further comprising:
a top module configured to have the dispenser unit at a front edge; and
a plurality of containment modules layered under the top module, each having a paper money containment unit in each of a front portion and a rear portion to contain the paper money, and
the take-in carrier takes the dispensed paper money in the paper money containment unit in the front portion of a containment module located on a top of the plurality of containment modules.
